(19) United States
(12) Patent Application Publication
(10) Pub. No.: US 2007/0021223 A1
(43) Pub. Date: Jan. 25, 2007

(54) Longitudinal plunging unit permitting axial positioning of the cage

(76) Inventors: Heiko Kossack, Koln (DE); Arnee Berger, Much (DE); Olaf Wolf, Siegburg (DE); Stephan Maucher, Siegburg (DE); Thomas Weckerling, Lohmar (DE); Martin Garzorz, Erlensee (DE); Christian Kramer, Hattersheim (DE)

Correspondence Address: ARTZ & ARTZ, P.C., 28333 TELEGRAPH RD., SUITE 250, SOUTHFIELD, MI, 48034, US

(21) Appl. No.: 10/562,429

(22) PCT Filed: Oct. 29, 2004
(86) PCT No.: PCT/EP04/12312

§ 371 Date: Apr. 6, 2006

(51) Int. Cl. F16D 3/06

(52) U.S. Cl. 464/167

(57) ABSTRACT

A longitudinal plunging unit for the transmission of torque in a drive assembly. It comprises a profiled sleeve (21) with circumferentially distributed, longitudinally extending first ball grooves (22); a profiled journal (11) with circumferentially distributed, longitudinally extending second ball grooves (12); balls (31) which are arranged in groups of pairs of first and second ball grooves (12, 22); a ball cage (41) which is arranged between the profiled sleeve (21) and the profiled journal (11) and fixes the balls (31) in their positions relative to one another; and a spring mechanism (51) which is supported on at least one axial stop (42, 43) and designed in such a way that, in an unloaded condition, the ball cage (42) is held at a distance from the at least one axial stop (42, 43).

### BACKGROUND

The invention relates to a longitudinal plunging unit for the transmission of torque between two parts which are axially displaceable relative to one another and which comprise a profiled journal with first circumferentially distributed, longitudinally extending ball grooves, a profiled sleeve with second circumferentially distributed, longitudinally extending ball grooves, balls which are arranged in groups of pairs of first and second ball grooves and a ball cage which is arranged between the profiled journal and the profiled sleeve and fixes the balls in their positions relative to one another.

Such longitudinal plunging units are used particularly in driveshafts in the driveline of a motor vehicle, as is known from DE 196 09 423 A1 for example. To compensate for tolerances regarding the distance between two attaching parts of the driveshaft during assembly and/or to compensate for changes in the distance between the attaching parts during operation, it must be possible to achieve a low-friction length adjustment under torque load.

The problem under operational conditions is that, under torque-free conditions at the longitudinal plunging unit, the ball cage—as a result of vibrations, axial impacts or weight forces—quickly abuts its axial end stops. In such a case, there is no need for a rolling movement of the balls. If subsequently, the longitudinal plunging unit is again torque-loaded and if, thereafter, there is a need for length adjusting movements, there occur sliding movements at the balls, with the ball cage resting against the end stop. This increases the displacement forces and the degree of wear and can lead to noise, vibration, harshness (NVH) problems which have an adverse effect on the driving comfort.

From U.S. Pat. No. 4,705,491, there is known a longitudinal plunging unit for transmitting torque which comprises a plurality of rows of balls arranged in a ball cage, wherein the balls of a row of balls consist of an elastic material and are radially pretensioned in the associated ball grooves.

U.S. Pat. No. 6,343,993 describes a similar longitudinal plunging unit wherein the balls are radially pretensioned by elastic elements.

DE 18 00 996 U proposes a longitudinal plunging unit for transmitting torque wherein the balls of one row of balls have a greater diameter than those of the other rows of balls.

U.S. Pat. No. 6,902,487 proposes a longitudinal plunging unit wherein the ball cage, in addition to the torque transmitting balls, holds rolling members made of a elastic material between the profiled sleeve and the profiled journal in such a way that they are able to roll. The rolling members are radially pretensioned and, during the transmission of torque, remain largely free from circumferential forces.

### SUMMARY OF THE INVENTION

It is an object of the present invention to provide a longitudinal plunging unit of the initially mentioned type which has a simple design and wherein the ball cage retains its position when in a torque-free condition.

In accordance with an embodiment of the invention, a longitudinal plunging unit for transmitting torque in a drive assembly is provided, comprising: a profiled sleeve with circumferentially distributed, longitudinally extending first ball grooves; a profiled journal with circumferentially distributed, longitudinally extending second ball grooves; balls which are arranged in groups of pairs of first and second ball grooves; a ball cage which is arranged between the profiled sleeve and the profiled journal and fixes the balls in their positions relative to one another; and a spring mechanism which is supported on at least one axial stop and designed in such a way that, in an unloaded condition, the ball cage is held at a distance from the at least one axial stop.

This assembly is advantageous in that it ensures that the ball cage is always held in its operating position. The use of springs prevents the ball cage—due to vibrations for example—from moving to one of the axial stops. A rolling displacement between the balls and the profiled journal and profiled sleeve respectively is always ensured. The displacement forces are minimized and any noise, vibration, harshness (NVH) problems are avoided.

According to one embodiment, the spring mechanism comprises a first spring which is arranged between the ball cage and the at least one axial stop. Using only one spring is advantageous in those applications where cage wandering occurs in one direction only. In addition, the spring mechanism can also comprise two springs which are supported on a second axial stop, with the first axial stop and the second axial stop being arranged at opposed ends of the ball cage. In this way it is ensured that the ball cage can be axially loaded from both ends and can be held in a central operating position.

According to a further embodiment, both the first and the second axial stop are formed at the profiled journal. Alternatively, the first and the second axial stop can also be formed at the profiled sleeve. According to a further embodiment, the first axial stop is associated with the profiled journal and the second axial stop is associated with the profiled sleeve. The axial stop associated with the profiled journal can be arranged at the end which enters the profiled sleeve. The axial stop associated with the profiled sleeve can be arranged at the end facing the aperture end. This embodiment wherein the axial stop arranged at the shaft end is associated with the profiled journal and wherein the axial stop facing the aperture end is associated with the profiled sleeve is advantageous in that there is formed an extraction stop for the profiled journal relative to the profiled sleeve. The profiled journal, in the extracted position, is supported via the first axial stop, the first spring and the ball cage and the second spring is supported against the second axial stop. The profiled journal is therefore prevented from unintentionally sliding out of the profiled sleeve, for instance during assembly.

According to another embodiment, the at least one axial stop is provided in the form of a securing ring which is axially fixed to the profiled sleeve and profiled hub respectively. This can be achieved, for example, by means of a securing ring which engages a suitably shaped annular groove, and it is advantageous to provide the annular groove in a region outside the ball grooves in order to carry out the turning operation in an uninterrupted cut. Alternatively or in addition to using a securing ring, at least one of the first and second axial stops can be provided in the form of a stop sleeve which is axially supported relative to the profiled sleeve or the profiled journal.

According to a further embodiment, the first and the second spring are pretensioned. In this way, the ball cage is prevented from moving loosely between the springs due to vibrations, On the contrary, the ball cage is held in a defined operating position. The first and the second spring can have different or identical lengths. Identical lengths are advantageous in that the ball cage is held symmetrically between the two axial stops. Different spring lengths are advantageous in certain applications where an asymmetrical position is desirable. The first spring and/or the second spring is preferably provided in the form of a helical spring which can be produced in a simple and cost-effective way.

According to yet another embodiment the first spring and/or the second spring has a greatest outer diameter which is smaller than a smallest inner diameter of the profiled sleeve in the region of the ball grooves. Furthermore, the first spring and/or the second spring has a smallest inner diameter which is greater than the greatest outer diameter of the profiled journal in the region of the ball grooves. As a result of this design, the springs can be freely axially displaced relative to the profiled sleeve and the profiled journal.

The first spring and/or the second spring can be arranged loosely between the ball cage and the axial stops, or, alternatively, it can be firmly connected to the ball cage. A firm connection of the ball cage to the spring on the one hand and of the spring to the axial stop on the other hand is advisable more particularly when using only one spring which can be tension or pressure-loaded without the ball cage moving out of its central position.

To prevent the ball cage from moving in operation, in addition to the spring, one group of balls positioned in a common radial plane comprises a greater diameter than the balls of the remaining groups of balls. In this way, the play between the profiled journal and the profiled sleeve is minimized and there is generated a slight pressure which prevents the ball cage from moving. Alternatively, it is proposed that at least one of the ball grooves of one of the two displaceable parts, i. e. the profiled sleeve or the profiled journal, is arranged outside the region of the regularly distributed remaining ball grooves, wherein the ball grooves of the other one of the two displaceable parts are regularly distributed across the circumference. In this way, too, there is generated a slight pressure which prevents the ball cage from moving when in operation.

### BRIEF DESCRIPTION OF THE DRAWINGS

Preferred embodiments will be explained below with reference to the drawings wherein

FIG. 1 is a longitudinal section through a first embodiment of an inventive longitudinal plunging unit.

FIG. 2 is a longitudinal section through a second embodiment of an inventive longitudinal plunging unit.

FIG. 3 is a longitudinal section through a third embodiment of an inventive longitudinal plunging unit.

FIG. 4 is a longitudinal section through a fourth embodiment of an inventive longitudinal plunging unit.

FIG. 5 is a longitudinal section through a fifth embodiment of an inventive longitudinal plunging unit.

FIG. 6 is a longitudinal section through a sixth embodiment of an inventive longitudinal plunging unit.

FIG. 7 is a longitudinal section through a seventh embodiment of an inventive longitudinal plunging unit.

FIG. 8 Is a longitudinal section through n eighth embodiment of an inventive longitudinal plunging unit.

FIG. 9 is a longitudinal section through a ninth embodiment of an inventive longitudinal plunging unit.

### DETAILED DESCRIPTION OF THE DRAWINGS

FIGS. 1 to 7 will initially be described jointly below. They each show a longitudinal plunging unit for the transmission of torque in a shaft assembly comprising a profiled journal 11 with first ball grooves 12 and a profiled sleeve 21 with second ball grooves 22. The ball grooves 12, 22 are arranged in corresponding circumferential positions, and the number of first ball grooves 12 can amount to a multiple of the number of second ball grooves 22. The first and second gall grooves 12, 22 arranged opposite one another carry balls 31 which are arranged in groups and which are held by a sleeve-shaped ball cage 41 in a way in which they cannot be lost and in identical axial arrangements.

The profiled journal 11 comprises an attaching end 13 with shaft teeth 14 for transmitting torque to an inner joint part of a constant velocity joint (not illustrated). The inner joint part is axially fixed by a securing ring which engages an annular groove 15 at the attaching end 13. The profiled sleeve 21 comprises an aperture 23 into which the profiled journal 11 is inserted by means of its end 16 which faces the shaft. In the aperture 23, a securing ring 27 is inserted into a matching annular groove, and when the profiled journal 11 is extracted from the profiled sleeve 21, the ball cage 41 is able to indirectly abut said securing ring 27. In this way, the profiled journal 11 is prevented from leaving the profiled sleeve 21, for example when being handled or mounted. However, in principle, it is possible to do without the securing ring 27 which prevents the profile journal from leaving the profiled sleeve. At its end opposite the aperture 23, the profiled sleeve 21 comprises an attaching end 24 with shaft teeth 25 for mounting a constant velocity joint (not shown) in a rotationally fast way. Said constant velocity joint is axially fixed by a securing ring which engages the annular groove 26.

In order to prevent the ball cage 41 from moving against one of the axial stops 42, 43 when in operation, thus preventing a rolling displacement of the torque transmitting balls 31, there is provided a spring mechanism 51 which holds the ball cage 41 in a central position. The spring mechanism 51 according to the embodiments according to FIGS. 1 to 5 comprises a first spring 52 which is arranged in such a way that a movement of the ball cage 41 towards the attaching end 24 of the profiled sleeve 21 is braked, as well as a second spring 53 which is arranged in such a way that a movement of the ball cage 41 towards the attaching end 13 of the profiled journal 11 is braked. The two springs 52, 53 are provided in the form of helical springs, with the radial tolerances being selected to be such that the springs 52, 53 are positioned between the profiled sleeve 21 and the profiled journal 11 with radial play and are thus axially freely movable.

In each of the embodiments, the first spring 52 and/or the second spring 53 can have a greatest outer diameter which is smaller than a smallest inner diameter of the profiled sleeve 21 in the region of the ball groves 22. Furthermore, the first spring 52 and/or the second spring 53 can have a smallest inner diameter which is greater than the greatest outer diameter of the profiled journal 11 in the region of the ball grooves 12. As a result of this design, the springs 52, 53 can be freely axially displaced relative to the profiled sleeve 21 and the profiled journal 11. The first spring 52 and/or the second spring 53 can also be arranged loosely between the ball cage 41 and the axial stops, or, alternatively, it can be firmly connected to the ball cage 41.

Below, the individual Figures will be described in respect of the differences between them. The embodiment according to FIG. 1 shows a longitudinal plunging unit having a first axial stop 42 associated with the profiled sleeve 21 and a second axial stop 43 associated with the profiled journal 11. The first axial stop 42 is provided in the form of a stop sleeve 44 which is inserted into the profiled sleeve 11 and which in a form-fitting way engages the ball groves 12. The profiled sleeve 44 is designed in such a way that the profiled journal 11 when entering same with its end 16 is able to pass through same, while the spring 52 abuts the profiled sleeve 44. The spring 52 is thus supported on the stop sleeve 44 and loads the ball cage 41 towards the aperture 23. The second axial stop 43 against which the second spring 53 is axially supported is formed by an annular collar 45 which increases the diameter of the profiled journal, with the outer diameter of the annular collar 45 being greater than the inner diameter of the second spring 53. The spring 53 thus axially abuts the annular collar 45 and loads the ball cage 41 towards the end 16 facing the shaft. As an alternative to the annular collar 45, the second axial stop 43 could be provided in the form of a securing ring 27 which engages a suitably shaped annular groove of the profiled journal. As a result of the two springs 52, 53, the ball cage 41, when in operation, is held symmetrically in a central position between the two axial stops 42, 43, with the lengths of the springs 52, 53 relative to the distance between the axial stops 42, 43 and the ball cage being such that the springs 52, 53 are pretensioned in the mounted condition and load the ball cage 41 into the central position.

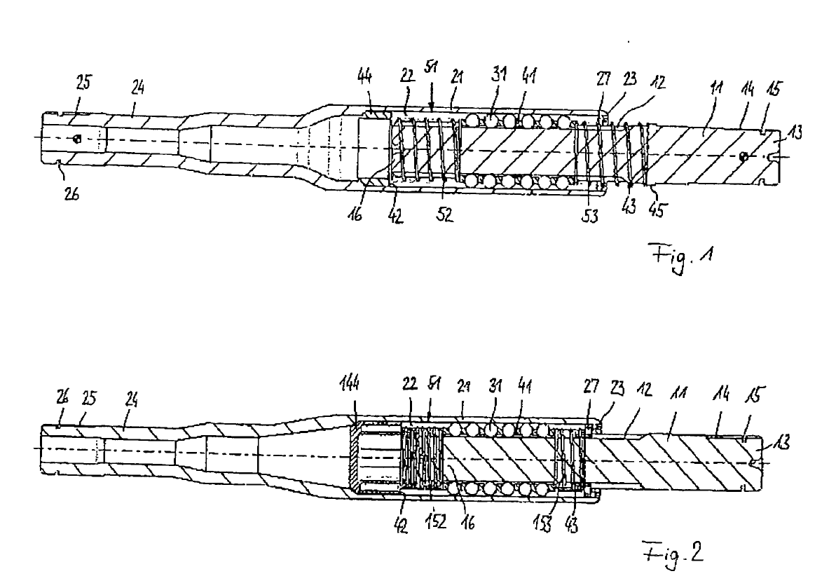

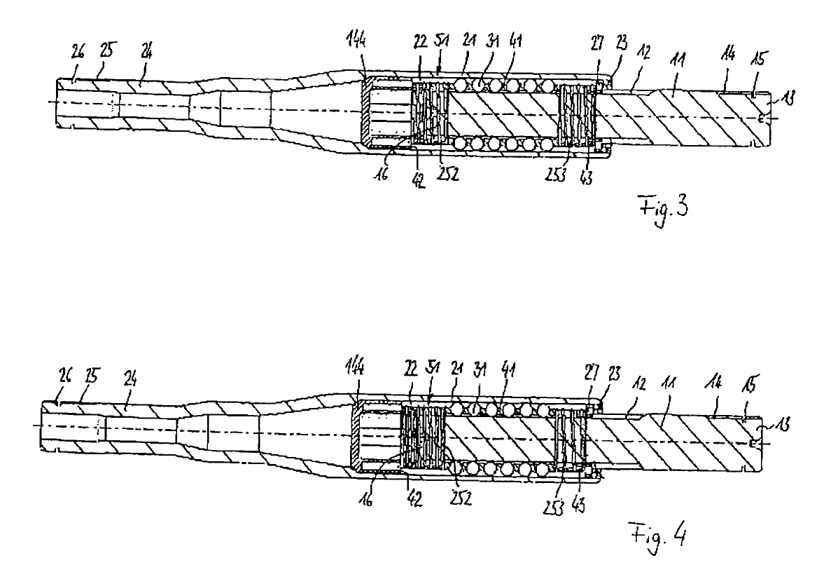

FIG. 2 shows an embodiment which is similar to that shown in FIG. 1. To that extent, reference is made to the description of same, with identical components having been given identical reference numbers, and modified components indexed by 100. In contrast to FIG. 1, both springs 152, 153 of the present embodiment are axially supported relative to the profiled sleeve 21. Furthermore, the ball cage 41 is held asymmetrically between the two axial stops 42, 43, which ensures that the first spring 152 associated with the end 16 facing the shaft is longer than the second spring 153 associated with the end 13 facing the attaching end. The first axial stop 42 against which the first spring 152 is axially supported is formed by the stop sleeve 144 which is inserted into the profiled sleeve 21. The profiled journal 11 can pass through the first spring 152. The second axial stop 43 against which the second spring 153 facing the attaching end is axially supported is formed by the securing ring 27 axially fixed in the profiled sleeve 21. The ball cage 41 is thus axially supported against the profiled sleeve 21 only, whereas the profiled journal 11 is freely displaceable relative to the springs 152, 153. In this embodiment, too, the lengths of the springs 152, 153 relative to the distance between the axial stops 42, 43 and the ball cage 41 are such that the springs 152, 153 are pretensioned in the mounted condition and load the ball cage 41 from both ends. As a result of the different lengths of the springs 152, 153, the ball cage 41, under standard operational conditions, assumes an eccentric position relative to the axial stops 42, 43, with the lengths of the springs 152, 153 being such that the ball cage 41, when in operation, is held in the desired position.

The embodiment according to FIG. 3 largely corresponds to that shown in FIG. 2, to the description of same reference is hereby made, with identical components having been given the same reference numbers, and modified components further indexed by 100. A first difference is that the springs 252, 253 of the present embodiment have the same lengths, so that the ball cage 41 is held symmetrically and centrally between the two axial stops 42, 43. Furthermore, the springs 252, 253 in the present embodiment are not pretensioned in the mounted condition. The total axial length of the springs 252, 253 is shorter than the distances between the axial stops 42, 43 and the ball cage 41. The springs 252, 253 are thus positioned loosely between the axial stops 42, 43 and the ball cage 41. Both axial stops 42, 43 are associated with the profiled sleeve 21.

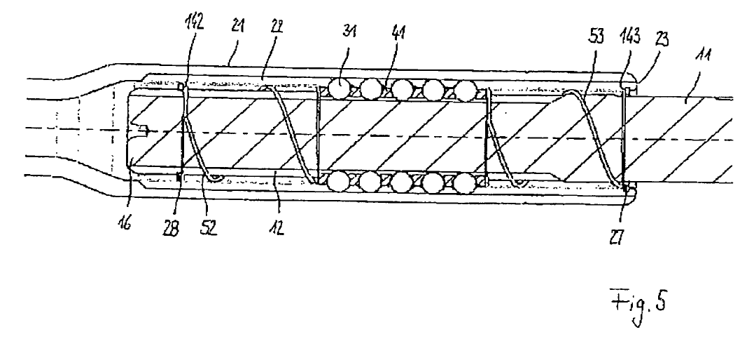

In FIG. 4, in contrast to FIG. 3, the axial lengths of the springs 352, 353 relative to the distances between the axial stops 42, 43 and the ball cage 41 have been calculated to be such that the springs 352, 353 are pretensioned in the mounted condition. The springs 352, 353 have different lengths, so that the ball cage 41, with reference to the axial stops 42, 43, assumes an eccentric position. Both axial stops 42, 43 are associated with the profiled sleeve.

The embodiment according to FIG. 5 is characterized in that the first axial stop 142 is associated with the profiled journal 11, whereas the second axial stop 143 is associated with the profiled sleeve 21. This is advantageous in that in each position of the ball cage 41, the spring forces acting from both ends on to the ball cage 41 are of identical magnitudes. The ball cage 41 is thus always held in the desired position. The first axial stop 142 for the first spring 52 is formed by a securing ring 28 which engages a matching annular groove at the end 16 of the profiled journal 11 facing the shaft. The second axial stop 143 for the second spring 53 is formed by a securing ring 27 which, at the end 23 facing the aperture, engages a matching annular groove of the profiled sleeve 21. This embodiment with the first securing ring 28 supported at the shaft end on the profiled journal 11 and with the second securing ring 27 being supported at the aperture end on the profiled sleeve 21 is advantageous in that there is formed an extraction stop for the profiled journal 11 relative to the profiled sleeve 21. The profiled journal 11, in the extracted position, is supported via the first axial stop 142, the first spring 52, the ball cage 41 and the second spring 53 against the second axial stop 143. The profiled journal 11 is therefore prevented from unintentionally sliding out of the profiled sleeve 21, for instance during assembly.

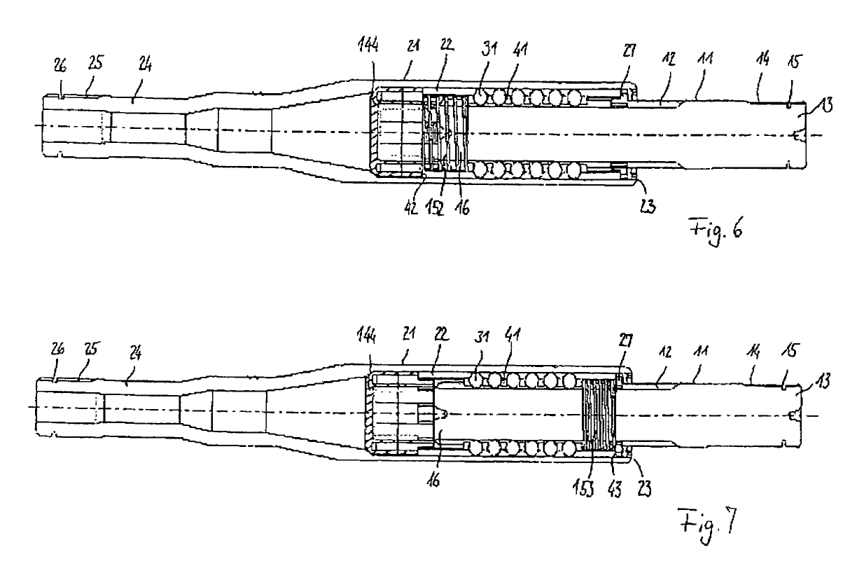

In respect of design and functioning, the embodiment according to FIG. 6 substantially corresponds to that shown in FIG. 2. To that extent, reference is made to the description of same, with identical components having been given identical reference numbers. The special feature of the present embodiment is that there is used only one single spring 152 which is arranged between the axial stop 42 and the ball cage 41. This is advantageous in that it permits more favorable production and assembly conditions because one component has been eliminated. The embodiment with only one spring can be used in those cases where the ball cage 41, due to vibrations, moves in one axial direction only. In the present case, the assembled condition of the longitudinal plunging unit is such that the ball cage 41 only moves towards the end 16 facing the shaft, with the ball cage 41 being axially supported on the stop sleeve 144 via the spring 152 inside the profiled sleeve 21. The spring 152 can be positioned loosely between the axial stop 42 and the ball cage 41 or it can be firmly connected to the ball cage 41. The length of the spring 152 is such that the ball cage 41, when in the operating condition, is held in the desired position.

In respect of design and functioning, the embodiment according to FIG. 7 substantially corresponds to that shown in FIG. 6. To that extent, reference is made to the description of same, with identical components having been given identical reference numbers. The only difference is that, in the present embodiment, the spring 153 is arranged at the aperture end, with the spring being arranged between the ball cage 41 and an axial stop 43 provided in the form of a securing ring 27. In the present case, the longitudinal plunging unit is assembled in such a way that the ball cage 41 only moves towards the end 23 facing the aperture, with the ball cage 41 being axially supported on the securing ring 27 via the spring 153.

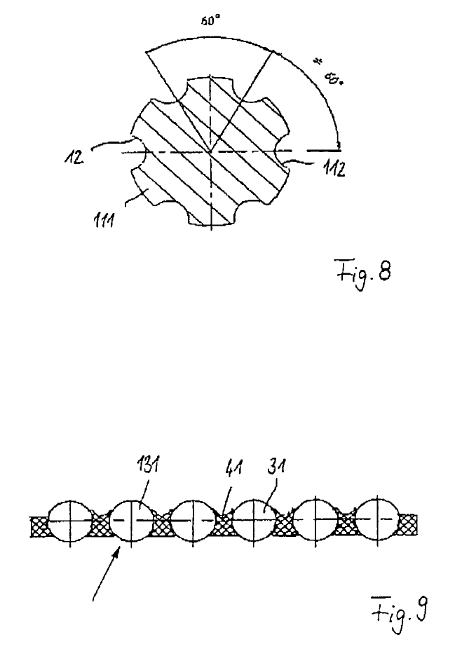

FIG. 8 deviates from the preceding embodiments according to FIGS. 1 to 7 in that it shows a profiled journal 111, with one ball groove 112 being arranged outside the remaining uniformly circumferentially distributed ball grooves 12. The ball grooves 22 of the outer profiled sleeve 21 are uniformly distributed around the circumference. Due to the deliberate slight pitch error of the one ball groove 112, the associated balls 31 are mounted so as to be subjected to a slight pressure. The increase in pressure is proposed in addition to the spring mechanism for preventing the ball cage 41 from being displaced. Alternatively, one ball groove of the profiled sleeve could be arranged outside the remaining uniformly circumferentially distributed outer ball grooves. In such a case, the inner ball grooves of the profiled journal would be uniformly distributed around the circumference.

FIG. 9 deviates from the preceding embodiments according to any one of FIGS. 1 to 7 in that it shows a ball cage 41 with balls 31 wherein one group of balls 131 positioned in a common radial plane comprises a slightly greater diameter than the balls 31 of the remaining groups. There is thus generated a slight resistance against axial displacement at the ball cage 41, which resistance remains effective even in those cases where the torque transmitting balls 31 are completely free from torque and thus load-free. Consequently, the greater pressure between the profiled journal 11 and the profiled sleeve 21 achieved by the group of balls 131 with the greater diameter constitutes an additional mechanism—in addition to the spring means—for preventing the ball cage 41 from being displaced. On the other hand, the friction generated by the balls 131 with the greater diameter is so slight that the displacement resistance of the longitudinal plunging unit under torque is not increased to any worthwhile extent.

What is claimed is:

1. A longitudinal plunging unit for the transmission of torque in a drive assembly, comprising:
a profiled sleeve with circumferentially distributed, longitudinally extending first ball grooves;
a profiled journal with circumferentially distributed, longitudinally extending second ball grooves;
balls which are arranged in groups of pairs of first and second ball grooves;
a ball cage which is arranged between the profiled sleeve and the profiled journal and fixes the balls in their positions relative to one another; and
a spring which is supported on at least one axial stop and designed in such a way that, in an unloaded condition, the ball cage is held at a distance from the at least one axial stop.

2.-17. (canceled)

18. A longitudinal plunging unit according to claim 1, wherein the spring comprises a first spring which is arranged between the ball cage and a first axial stop.

19. A longitudinal plunging unit according to claim 18, wherein the spring further comprises a second spring which is arranged between the ball cage and a second axial stop, wherein the first axial stop and the second axial stop are arranged on opposed sides of the ball cage.

20. A longitudinal plunging unit according to claim 1, wherein at least one of the axial stops is associated with the profiled journal.

21. A longitudinal plunging unit according to claim 19, wherein at least one of the axial stops is associated with the profiled journal.

22. A longitudinal plunging unit according to claim 1, wherein at least one of the axial stops is associated with the profiled sleeve.

23. A longitudinal plunging unit according to claim 19, wherein at least one of the axial stops is associated with the profiled sleeve.

24. A longitudinal plunging unit according to claim 19, wherein the first axial stop is associated with the profiled shaft and the second axial stop is associated with the profiled sleeve.

25. A longitudinal plunging unit according to claim 24, wherein first the axial stop is arranged at an inner end of the profiled journal, and the second axial stop is arranged at an open end of the sleeve.

26. A longitudinal plunging unit according to claim 1, wherein the at least one axial stop is a securing ring which is axially fixed to the profiled sleeve or to the profiled journal.

27. A longitudinal plunging unit according to claim 1, wherein the at least one axial stop is a stop sleeve which is axially supported relative to the profiled sleeve or the profiled journal.

28. A longitudinal plunging unit according to claim 19, wherein the first and second springs are pretensioned.

29. A longitudinal plunging unit according to claim 19, wherein the first and second springs are of different lengths.

30. A longitudinal plunging unit according to claim 19, wherein the first spring or the second spring is a helical spring.

31. A longitudinal plunging unit according to claim 1, wherein the spring comprises at least one helical spring surrounding a portion of the profiled journal and positioned between said profiled journal and said profiled sleeve with radial play.

32. A longitudinal plunging unit according to claim 18, wherein the first spring comprises a greatest outer diameter which is smaller than a smallest inner diameter of the profiled sleeve in the region of the ball grooves.

33. A longitudinal plunging unit according to claim 19, wherein the first or second spring comprises a greatest outer diameter which is smaller than a smallest inner diameter of the profiled sleeve in the region of the ball grooves.

34. A longitudinal plunging unit according to claim 18, wherein the first spring comprises a smallest inner diameter which is greater than a greatest outer diameter of the profiled journal in the region of the ball grooves.

35. A longitudinal plunging unit according to claim 19, wherein the first or second spring comprises a smallest inner diameter which is greater than a greatest outer diameter of the profiled journal in the region of the ball grooves.

36. A longitudinal plunging unit according to claim 1, wherein the spring is firmly connected to the ball cage.

37. A longitudinal plunging unit according to claim 1, wherein a group of balls positioned in a common radial plane comprises a greater diameter than the balls of the remaining groups of balls.

38. A longitudinal plunging unit according to claim 1, wherein at least one of the ball grooves of the profiled sleeve or the profiled journal, is arranged outside a region of the regularly distributed remaining ball grooves, wherein the ball grooves of the other of the profiled sleeve or profiled journal are regularly distributed across the circumference.
